(19) United States
(12) Patent Application Publication
(10) Pub. No.: US 2017/0016237 A1
(43) Pub. Date: Jan. 19, 2017

(54) Assembly and Method for Creating a Wall from a Flowable Material

(71) Applicant: LES PLASTIQUES CELLULAIRES POLYFORM INC., Granby (CA)

(72) Inventors: Léon Bombardier, Granby (CA); Murray Snider, Granby (CA); Mathieu Farah, Granby (CA); François Beauchesne, Granby (CA)

(21) Appl. No.: 14/799,191

(22) Filed: Jul. 14, 2015

(51) Int. Cl. E04G 11/08; B29C 39/26

(52) U.S. Cl. CPC E04G 11/08; B29C 39/26

(57) ABSTRACT

A wall form assembly for receiving a flowable material that sets and hardens into a desired formation having an exposed outer surface is disclosed. The wall form assembly includes a detachable panel provided with cavity shaping discrete protrusions distributed in rows on an inner face of the detachable panel, each of the rows extending in a longitudinal direction and comprising at least two of the discrete protrusions, and a foam panel. A plurality of connectors removably attach together the detachable panel and the foam panel in opposed and parallel spaced relation along the longitudinal direction so as to create a form for receiving the flowable material. Advantageously, the detachable panel along with the cavity shaping discrete protrusions can be easily removed from the hardened formation, thus providing an exposed outer surface which is substantially smooth and free of projections having recessed cavities. A related method is also disclosed.

### FIELD OF THE INVENTION

The present invention relates generally to the field of walls made from the hardening of flowable materials. More particularly, it relates to a wall form assembly for receiving the flowable material to create a wall, and to a method thereof.

### BACKGROUND OF THE INVENTION

A number of different techniques currently exist for using insulating forms for casting a concrete wall. Often, these systems comprise pairs of opposed foam panels generally made of rigid foam like polystyrene which define concrete-receiving cavities therebetween. Once the concrete is solidified, the foam panels remain in place to insulate the wall. These foam panels are typically fixed apart from each other before the pouring of concrete by means of spacers comprising a pair of parallel lateral attachment flanges, each flange being embedded or inserted in one of the two opposed foam panels, and a connecting web interconnecting the flanges.

The following US patent documents disclose examples of different prior art walls and methods: U.S. Pat. Nos. 7,082,732 B2; 7,024,833 B1; 6,668,503; 6,609,340 B2; 6,401,419; 6,256,962; 4,889,310; 2006/0179135 A1; and 2009/0179135.

The following patent documents are also known: CA U.S. Pat. No. 2,256,261; CA U.S. Pat. No. 2,358,195; and JP 2001317142.

It is sometimes desired or indeed necessary to remove a form wall or foam panel, for example the one facing toward the inside of a structure, from the concrete so as to expose the surface of the concrete wall. This can be the case with stair cases in buildings, for example, where the regulatory environment or building code sometimes requires that the interior concrete walls be free of any material so as to improve the walls fire-resistant characteristics. These exposed concrete walls are desired for other structures as well, such as underground garages.

However, it is known that removing the foam panels from the concrete wall is difficult. Since the foam panels are often well integrated with the concrete wall, they must be torn from the wall, typically by hand, which can be extremely labour-intensive for large wall areas. Furthermore, such a removal operation creates significant waste because the torn panel is not reusable, and it may also result in additional disposal costs.

U.S. Pat. No. 6,314,694 B1 discloses a one-sided, insulated formwork used in the construction of walls from pourable building material, such as concrete, including an insulating panel connectable to a removable panel by a connecting structure, which may include a permanent reinforcement embedded in the insulating panel. The connecting structure may have a tie removably attachable to the reinforcement, or the reinforcement and tie may constitute a monolithic structure. The tie may be asymmetric in shape to facilitate distribution of loads across the insulating panel, detachment of the removable panel, and enhancement of the structural integrity of the finished wall. One drawback of such a formwork is that, upon removal of the removable panel, a channel or fixture may be left integrated in the finished wall and visible to an observer of the wall. This can be unsightly or unnecessary, and it may be required to remove such a channel, further adding to labour and material costs.

A further drawback of such foam panels is that they are not often designed to form a smooth exposed wall surface, or one that is free of projecting objects such as reinforcing bars or fasteners which must be chiselled from the exposed wall. This can result in a visually unappealing exposed wall, or one that must be reworked or touched-up, further increasing labour and material costs.

The following references disclose other examples of systems to create concrete walls: U.S. Pat. No. 6,681,539 B2; U.S. Pat. No. 5,497,592; U.S. Pat. No. 4,085,495; U.S. Pat. No. 3,995,825; and JP 2007291758.

There is thus a need for a wall form having panels which can be easily arranged on site so as to facilitate installation, and where at least one of the panels can easily be removed so as to leave a smooth exposed wall surface or one that is free of projecting objects.

### SUMMARY OF THE INVENTION

An object of the present invention is to provide a wall form that will satisfy the above-mentioned need, and more particularly to propose a wall form assembly and method therefor which aim to overcome the drawbacks of the presently available methods and apparatuses for making wall forms.

The present invention is directed towards a wall form assembly for receiving a flowable material that sets and hardens into a desired formation having an exposed outer surface. The assembly comprises:
a detachable panel provided with cavity shaping discrete protrusions distributed in rows on an inner face of the detachable panel, each of the rows extending in a longitudinal direction and comprising at least two of the discrete protrusions;
a foam panel;
a plurality of connectors for removably attaching together the detachable panel and the foam panel in opposed and parallel spaced relation along the longitudinal direction so as to create a form for receiving the flowable material, each of the connectors comprising:
   a first elongated side member inserted longitudinally inside the foam panel; and
   a second elongated side member opposed to the first side member and being devised to face one of the rows of the discrete protrusions when the detachable panel and the foam panel are attached together; and
a plurality of removable fasteners insertable through the discrete protrusions and the second elongated side members of the plurality of connectors to removably attach the detachable panel to the connector;
   whereby, once the flowable material has set and hardened, the detachable panel is removed by removing the removable fasteners; thereby leaving a plurality of recessed cavities within the exposed outer surface of the formation.

In one possible embodiment the cavity shaping discrete protrusions are insertable pegs. Each of these insertable pegs is receivable within a through hole in the detachable panel, and optionally press-fitted within the through hole, to protrude from the inner face of the detachable panel for forming one of the cavity shaping discrete protrusions.

In one other possible embodiment, the insertable pegs are hollowed to receive one of the removable fasteners therethrough, such as screws. In such embodiment, the second side member of each of the connectors may comprise an elongated support frame; and at least one screw-receiving sleeve extending transversally from the support frame for receiving one of the screws.

The at least one screw-receiving sleeve may have a free end for abutting against one of the cavity shaping discrete protrusions when the detachable panel and the foam panel are attached together.

The second side member may advantageously further comprise a reinforcing structure to reinforce the at least one screw-receiving sleeve against loads generated by the flowable material. Such reinforcing structure may expand between the free end of each of the at least one screw-receiving sleeve toward the elongated support frame so as to form a substantially triangular shape.

Also provided is a method for creating a wall formation from a flowable material that sets and hardens, the method comprising the steps of:
a) providing a foam panel;
b) providing a detachable panel provided with cavity shaping discrete protrusions distributed in rows on an inner face of the detachable panel, each of the rows extending in a longitudinal direction and comprising at least two of the discrete protrusions;
c) providing a plurality of connectors for removably attaching together the detachable panel and the foam panel in opposed and parallel spaced relation along the longitudinal direction so as to create a form for receiving the flowable material, each of the connectors comprising:
   a first elongated side member inserted longitudinally inside the foam panel; and
   a second elongated side member opposed to the first side member and being devised to face one of the rows when the detachable panel and the foam panel are removably attached together;
d) positioning the detachable panel and the foam panel face to face and aligning each row of the discrete protrusions with one of the first elongated side members;
e) removably attaching the detachable panel and the foam panel using removable fasteners insertable through the discrete protrusions and the second elongated side members, thereby forming a form;
f) pouring the flowable material into the form;
g) allowing the flowable material to set and harden within the form so as to create the wall formation;
h) removing the plurality of removable fasteners from the discrete protrusions and the second elongated side members; and
i) removing the detachable panel from the wall formation so as to expose the outer surface and recessed cavities formed within the exposed outer surface of the wall formation by the cavity shaping discrete protrusions.

Thanks to the easily detachable panel, the present invention allows for one of the outer surfaces of the wall, or a part thereof, to be exposed and thus accessible, if need be. And thanks to the cavity shaping discrete protrusions provided on the detachable panel, which leave cavities within the exposed outer surface of the formation when the detachable panel is removed, the invention helps to ensure that such an exposed outer surface is relatively smooth, and free of protrusions and nicks resulting from the setting and hardening of the flowable materials.

Other features and objects of the present invention will become more apparent from the description that follows of optional embodiments thereof, having reference to the appended drawings and given as examples only as to how the invention may be put into practice.

### BRIEF DESCRIPTION OF THE DRAWINGS

FIG. 1 is a perspective view of a wall form assembly provided with a plurality of connectors, according to an optional embodiment of the present invention;

FIG. 2 is a perspective view of a foam panel, according to an optional embodiment of the present invention;

FIG. 3 is a perspective view of a plurality of wall form assemblies of FIG. 1 arranged into a mold for creating a wall formation, according to an optional embodiment of the present invention;

FIG. 4 is the same view as FIG. 3, showing the mold filled with a flowable material that has set and hardened to form the wall formation;

FIG. 5 is also the same view as FIGS. 3 and 4, showing one of the detachable panels being removed so as to expose the outer surface of the wall formation;

FIG. 6 is a perspective view of a detachable panel provided with cavity shaping discrete protrusions distributed in rows on the inner face of the detachable panel, according to an optional embodiment of the present invention;

FIG. 7 is a perspective view of an exemplary connector used for tying together the detachable panel of FIG. 6 and a foam panel;

FIG. 8 is a side view of the detachable panel of FIG. 6 illustrating the alignment of the cavity shaping discrete protrusions of the detachable panel with the sleeves of the connector of FIG. 7;

FIG. 9 is an enlarged side cross sectional view of a portion of the detachable panel of FIG. 6 removably connected to the connector of FIG. 7 via the cavity shaping discrete protrusions with a mechanical fastener;

FIG. 10 is another perspective view of the form assembly of FIG. 1 shown without the foam panel;

FIG. 11 is a perspective view of the detachable panel of FIG. 1 showing mechanical fasteners being used to removably connect the detachable panel to a plurality of connectors, according to an optional embodiment of the present invention;

FIG. 12 is an enlarged side cross sectional view of a portion of the detachable panel of FIG. 1 illustrating the insertion of a peg into a through hole of the detachable panel in accordance with an optional embodiment of the present invention;

FIG. 13 is an enlarged side cross-sectional view of a portion of the wall formation with the detachable panel being removed and thereby exposing a recessed cavity formed in the wall formation;

FIG. 14 is an enlarged view of the encircled portion in FIG. 5; and

FIG. 15 is a flow chart illustrating a method for creating a wall formation from a flowable material that sets and hardens.

### DESCRIPTION OF OPTIONAL EMBODIMENTS

The present invention can be employed to make a form, or plurality of forms, for receiving a pour of a flowable material, such as concrete, cement, or the like, into a cavity or void defined by the form. Once the flowable material sets or hardens into a formation defined by the form, the present invention allows for an outer surface of the formation to be exposed, thereby providing an exposed outer surface which can be smooth, visually appealing, free of protrusions and abrasions and which has recessed cavities formed within the finished formation which can be used as anchor points to allow for the mounting of appropriate fixtures or supports.

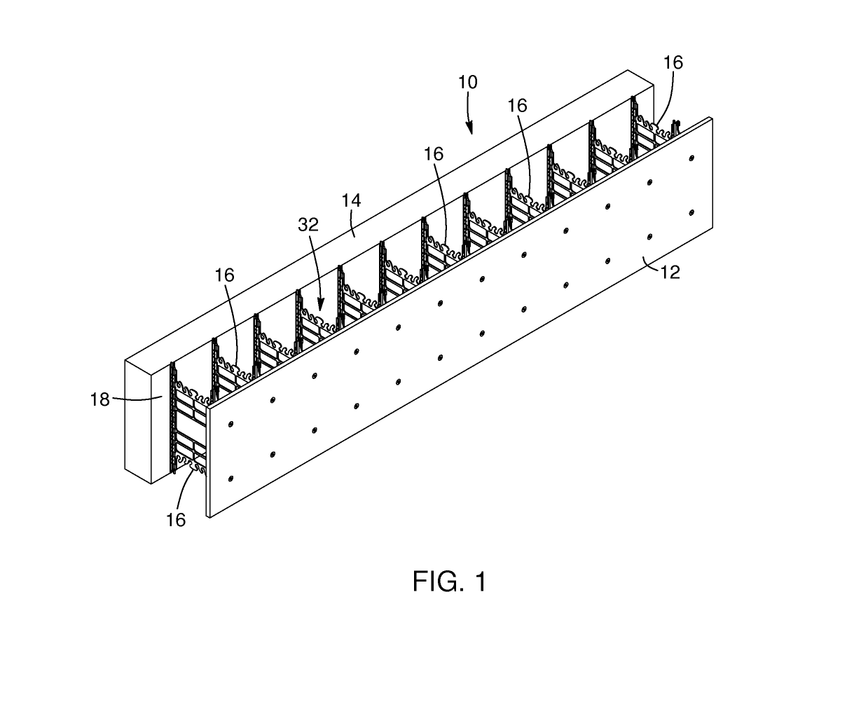

Now referring to FIG. 1, according to an aspect of the present invention, there is provided a wall form assembly 10 which can receive the flowable material and act as a form in which the flowable material can set and harden so as to create the desired formation, such as a concrete wall. The wall form assembly 10 has a detachable panel 12 and a foam panel 14, as well as a plurality of connectors 16, which will be described hereinbelow, for maintaining the panels 12, 14 together to create the form.

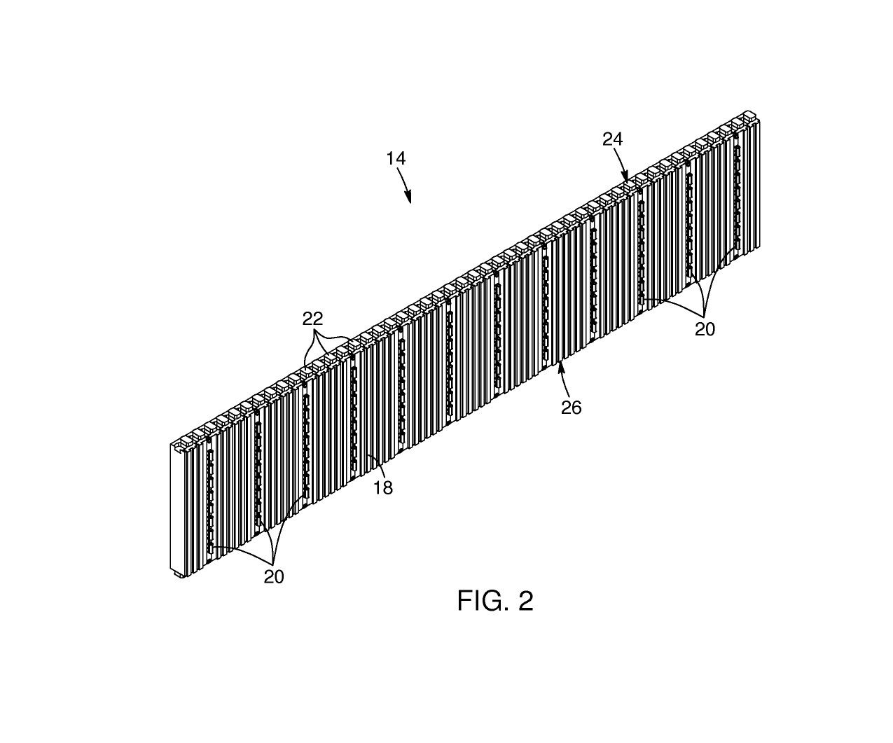

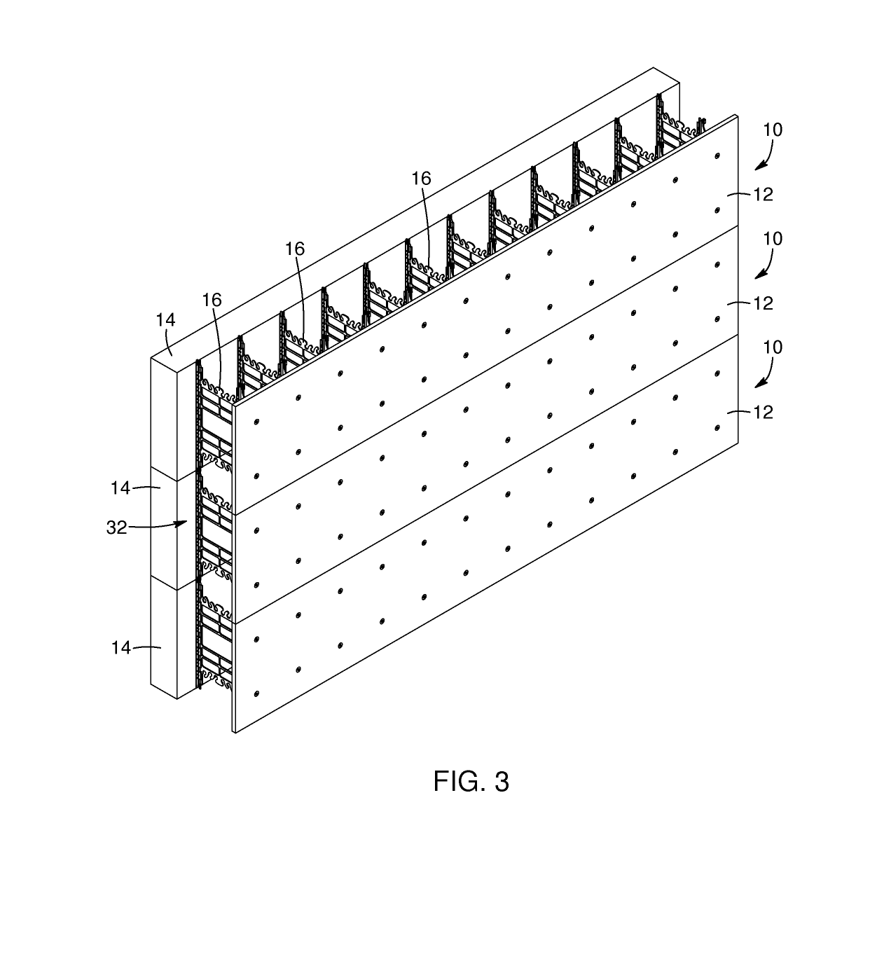

The detachable panel 12 can be of any suitable shape and size to create the desired form or wall formation, and it can be made of wood, plywood, plastic or another suitable material. The foam panel 14 can be made of polystyrene foam, or any other suitable insulating material and can also take any suitable form. For example, as shown in FIG. 2, the foam panel 14 can have an “undulated” or “ridged” inner surface 18. In addition, the inner surface 18 of the foam panel 14 can have mounts 20 integrated therein for mounting to the connectors 16 or a portion thereof. The foam panel 14 can also have joints 22 mounted on the top surface 24 and bottom surface 26 of the foam panel 14 for connecting vertically for example to other adjacent respective foam panels 14 (see FIG. 3). Of note, the terms “top” and “bottom” are used to facilitate reading of the description, and persons skilled in the art of wall form assemblies know that, when in use, the wall form assembly 10 can be placed in different orientations such that the “top surface 24” and the “bottom surface 26” are reversible for example.

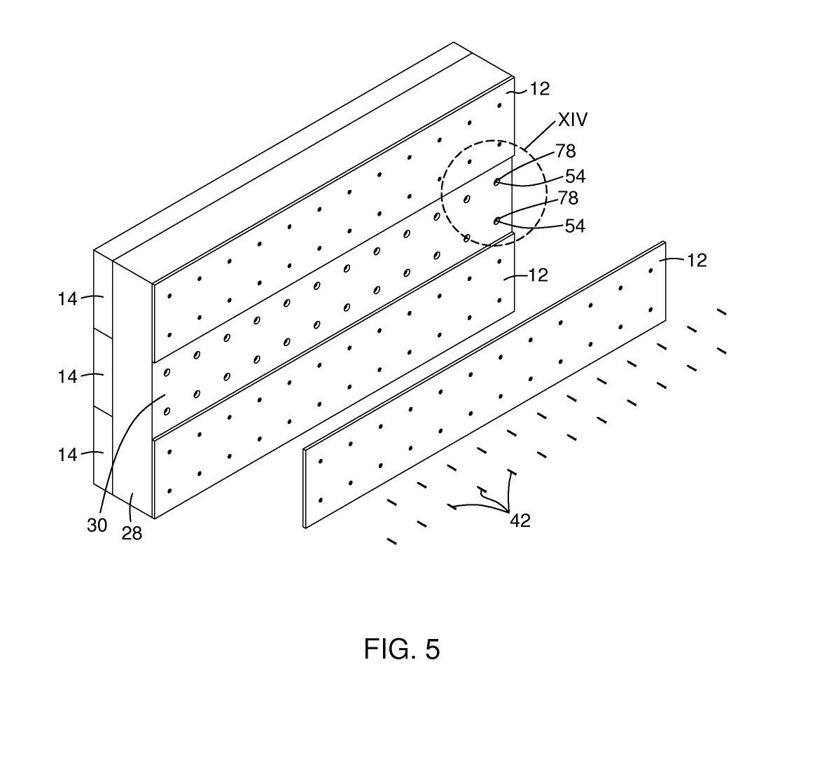

Now referring also to FIGS. 3, 4, 5, multiple wall form assemblies 10 can be used to create the wall formation 28, by stacking wall form assemblies 10 one atop another as illustratively shown, or side by side depending on the formation 28 to be created. As can be appreciated by referring to FIGS. 3 to 5, once the poured flowable material has set and hardened within the form defined by the multiple wall form assemblies 10, the detachable panels 12 can be removed as shown in FIG. 5, thereby exposing an outer surface 30 of the concrete wall formation 28, for example, the concrete wall formation 28 facing toward the interior of a structure. This interior can be the interior of stair cases in buildings, for example, where the regulatory environment or building code sometimes requires that the interior concrete walls of the stair cases be free of any material so as to improve the walls fire-resistant characteristics. These exposed concrete walls are desired for other structures as well, such as underground garages. While the outer surface 30 of the concrete wall formation 28 being formed has been illustrated with reference to it facing toward the interior of a structure, one skilled in the art will understand that the present invention could equally be used to create a concrete wall with an outer surface 30 facing the exterior of the structure.

Now referring back to FIG. 1, the connectors 16 are used to removably tie or attach together the detachable panel 12 and the foam panel 14 and to maintain the panels 12,14 in opposed and parallel spaced relation. The expression “opposed and parallel spaced relation” refers to the orientation of the panels 12,14 when connected to the connectors 16. Such an orientation allows for the panels 12,14 to be distanced or “spaced” from each other so as to define a cavity or void 32 defining the form, and further allows the panels 12,14 to be aligned parallel with each other. Although the orientation of the panels 12,14 is shown in FIG. 1 as being parallel and in a horizontal alignment, a person skilled in the art will understand that the panels 12,14 can also have other alignments, such as vertical, angled, or any combination in between. The connectors 16 connect the panels 12,14 along a longitudinal direction of the panels 12, 14. The expression “along a longitudinal direction” refers to the placement of the connectors 16 when connected to the panels 12,14. An example of such an orientation is provided in FIG. 1, which is illustratively an orientation perpendicular to the length of the panels 12,14. Alternatively, such an orientation may be in a direction parallel to the length of the panels 12,14. As shown in FIG. 1, the connectors 16 are vertically positioned between both panels 12,14. It can thus be appreciated that the tying or attaching together of the panels 12,14 by the connectors 16 creates the wall form assembly 10 defining the void 32, which can receive the flowable material. The connectors 16 can optionally be abutting to adjacent connectors 16 in a vertical orientation when wall form assemblies 10 are stacked one atop another as in FIGS. 3, 4, 5, or side by side (not shown) so as to combine multiple wall form assemblies 10 for creating the form. Optionally, the connectors 16 can be symmetrical for providing “reversibility” functionality, meaning that it can be used regardless of which side is up or down. Upon setting and hardening of the flowable material received in the void 32, the desired formation 28 will be created, as further explained herein below.

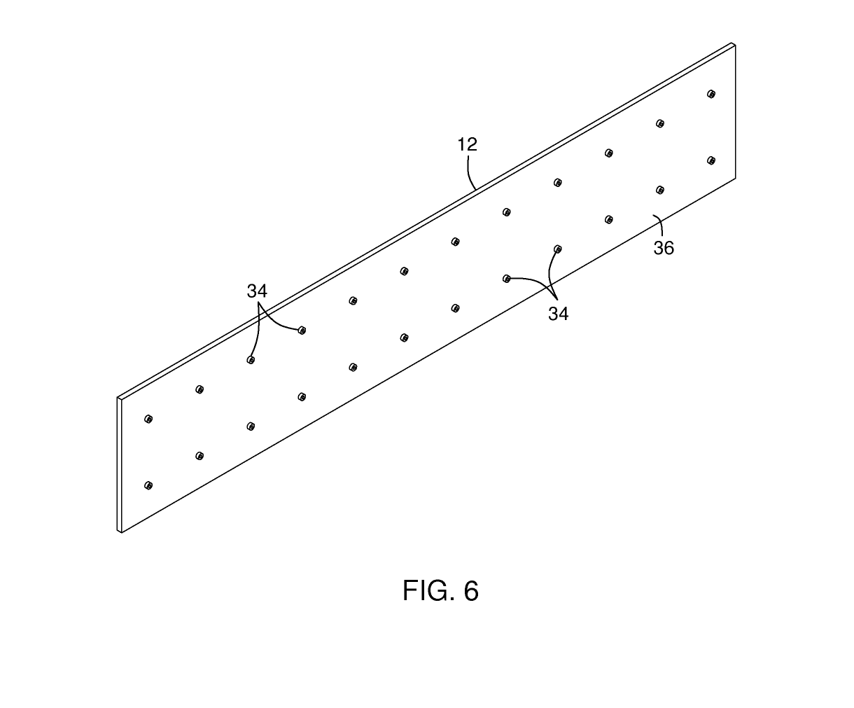

Now referring to FIG. 6, in addition to FIGS. 1 and 5, the detachable panel 12 is provided with a plurality of cavity shaping discrete protrusions 34 distributed in rows on an inner face 36 of the detachable panel 12 which will project into the void 32 when the detachable panel 12 and the foam panel 14 are removably attached together. Each of the rows illustratively extends along the longitudinal direction of the detachable panel 12 and comprises at least two of the cavity shaping discrete protrusions 34. While the present invention is illustrated herein with reference to cavity shaping discrete protrusions 34 distributed in rows extending along the longitudinal direction of the detachable panel 12, a person skilled in the art will understand that the cavity shaping discrete protrusions 34 may be distributed along other orientations on the inner face 36 and not to distributions limited along vertical rows as illustrated in FIG. 6. As will be explained further hereinbelow, thanks to these cavity shaping discrete protrusions 34, recessed cavities will be formed within the exposed outer surface 30 of the formation 28 when the detachable panel 12 is removed from the formation 28.

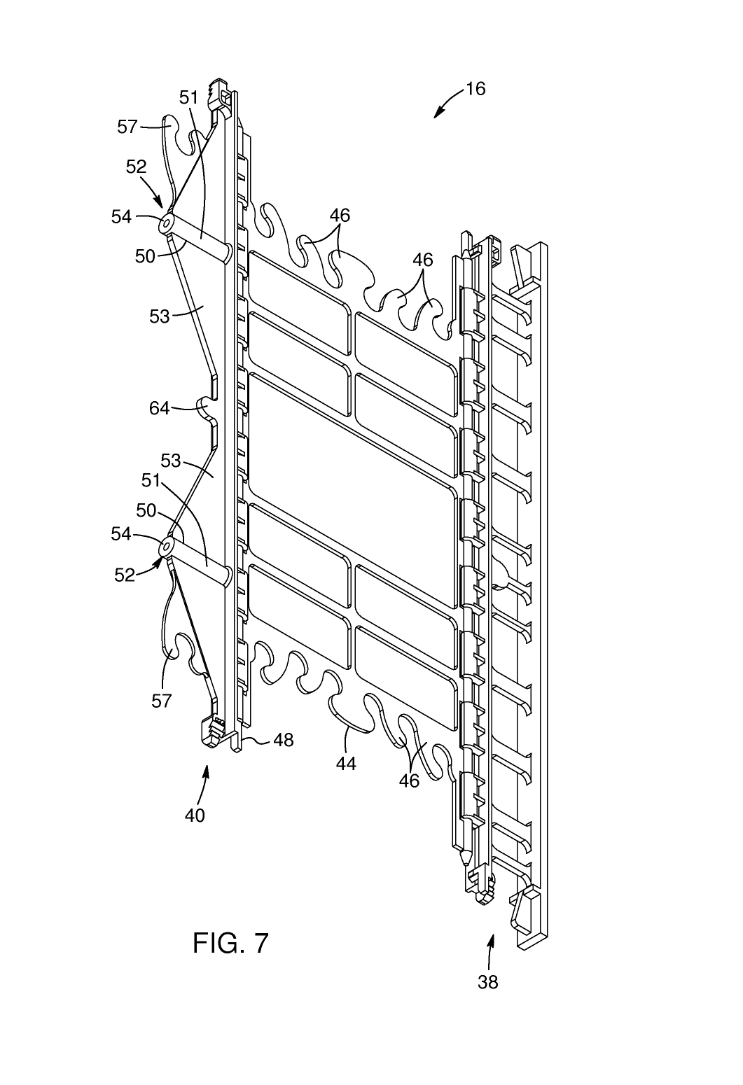

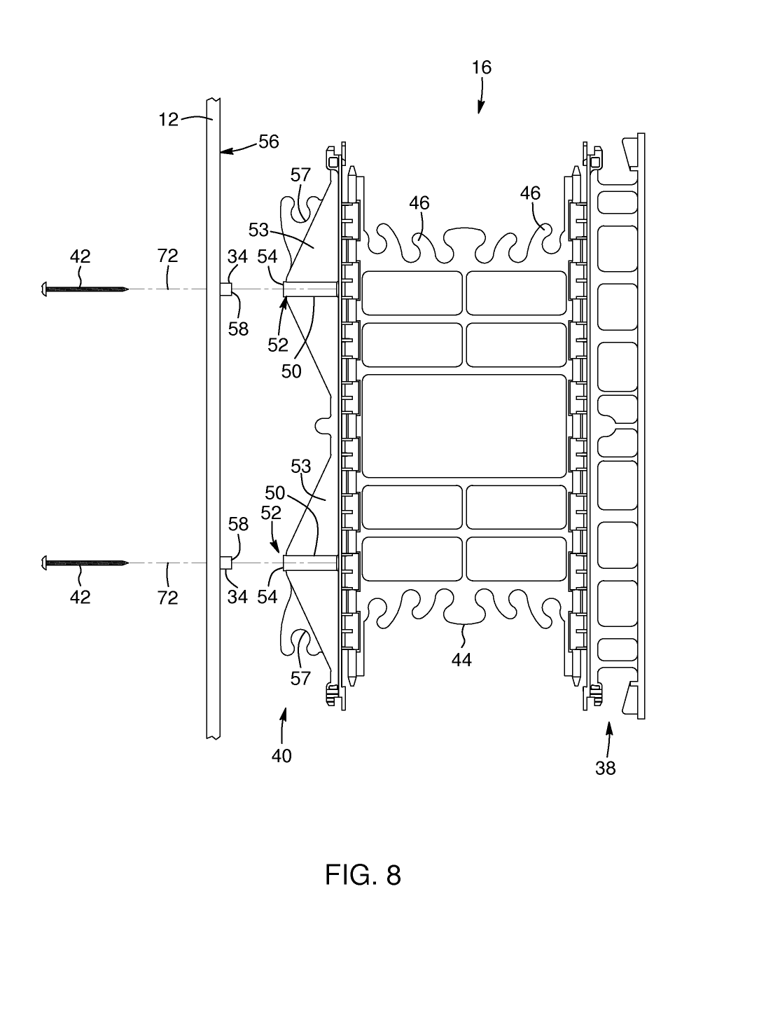

Now referring to FIGS. 7 and 8, in addition to FIGS. 1 and 2, the connectors 16 will now be further described. The connectors 16 each illustratively has a first elongated side member 38 (or simply “first member”) and an opposed second elongated side member 40 (or simply “second member”). The term “opposed”, when used to describe the relationship of the first and second members 38,40, refers to their position on distinct, or “opposite” sides of the connector 16. The first member 38 is typically embedded along a longitudinal direction within the foam panel 14, and forms an integral part thereof, as shown in FIG. 1. Such integration of the first member 38 with the foam panel 14 can occur during the manufacture or assembly of the foam panel 14, for example during which the first member 38 can be embedded along an orientation perpendicular to the length of the foam panel 14 (i.e. a “vertical” orientation). The embedding of the first member 38 can allow for the connector 16 to better support the loads generated by the flowable material as it is poured into the void 32, or as it settles or hardens therein. Alternatively, in another embodiment (not illustrated), the first member 38 can be connected to the mount 20, or slid within an appropriately configured channel provided within the foam panel 14, as in the assembly described in for example, U.S. Pat. No. 5,065,561 to Mason or U.S. Pat. No. 5,704,180 to Boeck

Still referring to FIGS. 7 and 8, the connector 16 optionally has a web member 44 which connects longitudinally (i.e. in a vertical orientation) the first member 38 with the second member 40. The web member 44 also helps to support the connector 16 against the loads produced by the flowable material. As an example, the pouring of the flowable material into the void 32 formed between the panels 12,14 can place significant pressure on the panels 12,14, forcing them to move or separate. In connecting the panels 12,14 together, the web member 44 thus “anchors” the panels 12,14, and helps them better resist these loads. It is thus apparent that the web member 44 is not limited to the shape shown in FIGS. 7 and 8 and can have a different shape, size, or configuration, depending upon the following non-exhaustive list of factors: the anticipated loads produced by the flowable material, the size of the panels 12,14, the cost of materials, etc. Optionally, the web member 44 can have one or more retaining members 46 into which can be inserted and maintained a corresponding reinforcement bar (not shown), disposed horizontally.

Still referring to FIGS. 7 and 8, the second member 40 also includes an elongated support frame 48. The support frame 48 can extend along the entire length of the second member 40, or only along a portion thereof. The support frame 48 illustratively connects with the web member 44, so as to provide a link between the second member 40 and the first member 38. The support frame 48 can connect to the web member 44 using many different techniques. In one possible embodiment, the support frame 48 can consist of an elongated rod extending the length of the second member 40, which can be slid into corresponding grooves protruding from one side of the web member 44. In another possible embodiment, the support frame 48 and the web member 44 can interlock with each other, using a “click”-producing mechanism. In yet another possible embodiment, the support frame 48 is mounted like a hinge to the web member 44, which can permit the support frame 48 (and thus the second member 40) to pivot or rotate about the web member 44. This last configuration may be suitable for transportation and storage purposes, because it may allow the connector 16 to collapse onto itself.

Still referring to FIGS. 7 and 8, the second member 40 further includes at least one fastener-receiving sleeve 50 (or simply “sleeve”). The at least one sleeve 50 can be many sleeves 50 distributed throughout the second member 40. Optionally, the plurality of sleeves 50 can be aligned vertically with each other. Each sleeve 50 can extend transversally from the support frame 48. The expression “extend transversally” refers to the orientation of the sleeve 50, in that the sleeve 50 extends substantially perpendicularly from the support frame 48. The sleeve 50 is “fastener-receiving”, meaning that it can receive a fastener 42 such as a screw, nail, bolt or other suitable mechanical fastener which would permit the sleeve 50 to be removably secured to the detachable panel 12, and removed therefrom in a manner as will be described hereinbelow. For example the sleeve 50 may be provided with threads (not shown) there along for engaging corresponding fastener threads provided on the fastener 42 when received within sleeve 50, for example during rotation of the screw embodiment of the fastener 42 in the sleeve 50. The sleeve 50 in combination with the fastener 42 thus allows the detachable panel 12 to be mounted to the second member 40 and also allows for the detachable panel 12 to be removed from the second member 40.

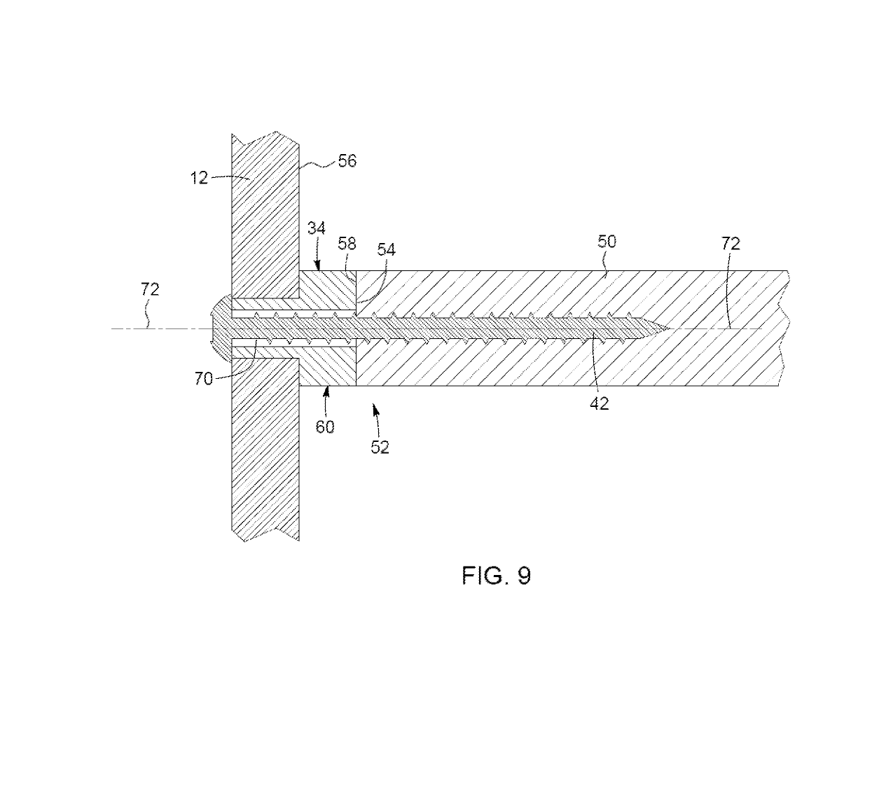

Now referring to FIG. 9, in addition to FIGS. 7 and 8, the sleeve 50 has a free end 52 located at one end of the sleeve 50 and away from the support frame 48. It is therefore “free” because it corresponds to the end of the sleeve 50 not joined to the support frame 48. The free end 52 has an exterior face 54 facing away from the support frame 48, and spaced from the interior face 56 of the detachable panel 12 when the second member 40 is secured thereto via the cavity shaping discrete protrusions 34 such that the exterior face 54 abuts against an interior protrusion surface 58 of the cavity shaping discrete protrusion 34 when a row of cavity shaping discrete protrusions 34 is aligned with the second member 40 as will be described hereinbelow.

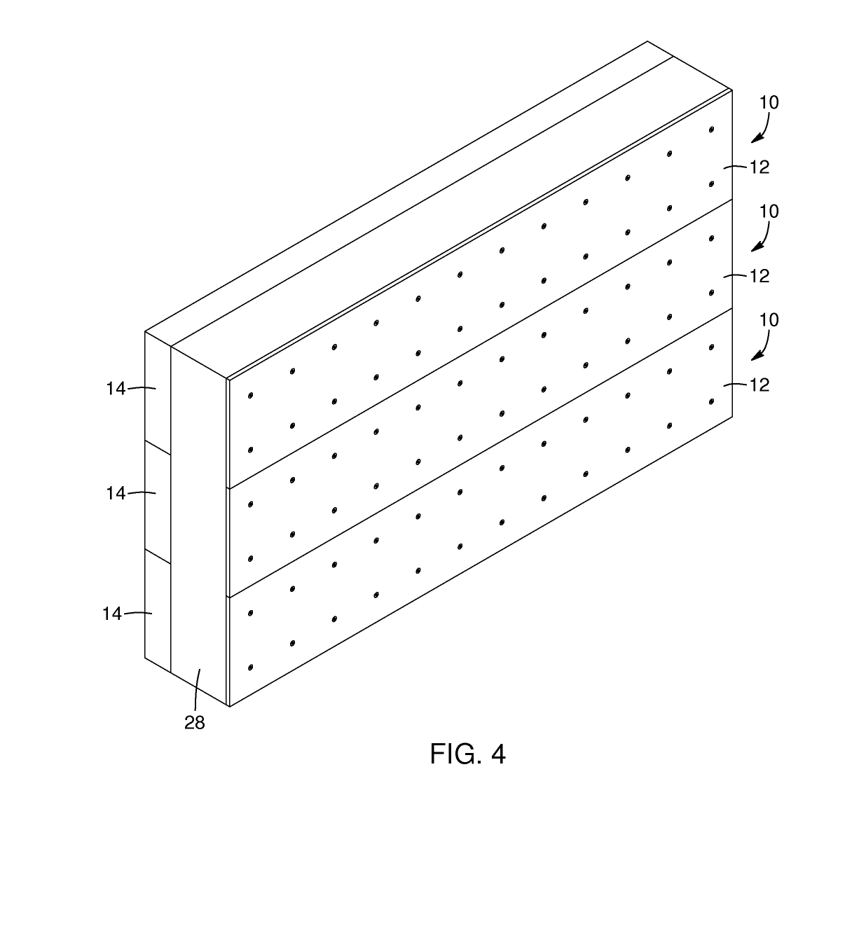

Still referring to FIGS. 7 and 8, in addition to FIGS. 4 and 5, in some optional embodiments, the sleeve 50 has a main portion 51, which extends from the support frame 48. The main portion 51 can take on any suitable configuration or shape. Optionally, the main portion 51 is a hollow tube. Such a hollow tube allows for the formation of an open passage in the exposed outer surface 30 of the formation 28. Indeed, once the flowable material is poured into the void 32, the hollow tube main portion 51 prevents the flowable material from filling the volume enclosed by the hollow tube, which results in this volume forming the open passage when the flowable material sets and hardens.

Still referring to FIGS. 7 and 8, in some optional embodiments, the second member 40 includes a reinforcing structure 53. The reinforcing structure 53 reinforces the sleeve 50 against the loads which may be generated by the flowable material. The reinforcing structure 53 can thus take any suitable form or configuration to achieve such functionality. In one possible configuration, an example of which is shown in FIG. 8, the reinforcing structure 53 expands between the free end 52 of each sleeve 50 toward the support frame 48, thereby forming a shape that is substantially triangular. Such a triangular reinforcing structure 53 may better support the load or weight of the flowable material, and thus help to keep the panels 12,14 secured together. In another possible configuration, the expanded reinforcing structure 53 can expand until just short of the support frame 48, and form a continuous link with the adjacent reinforcing structure 53 via a force link 55, which may help in distributing and resisting the loads generated by the flowable material. Optionally, the reinforcing structure 53 can have a retaining member 57 into which a corresponding horizontal retaining bar (i.e. rebar) (not shown) can be inserted and retained, such as through press-fitting, as but one example. The retention of such a retaining bar in the retaining member 57 can help the connector 16 to better resist the loads, and also serve to support the formation 28 when the flowable material sets and hardens.

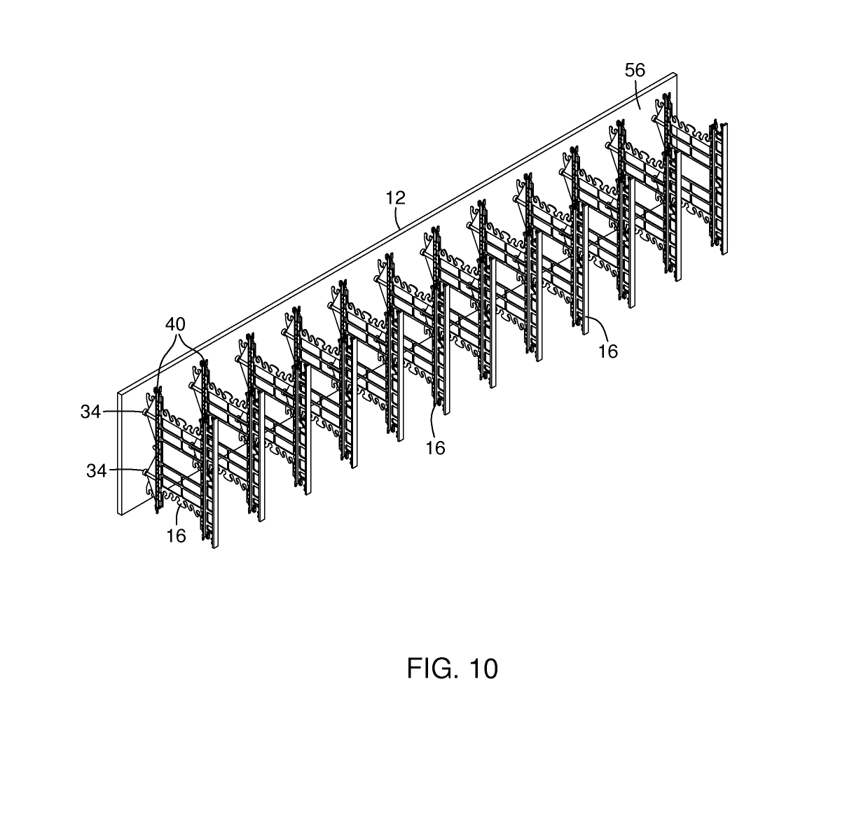

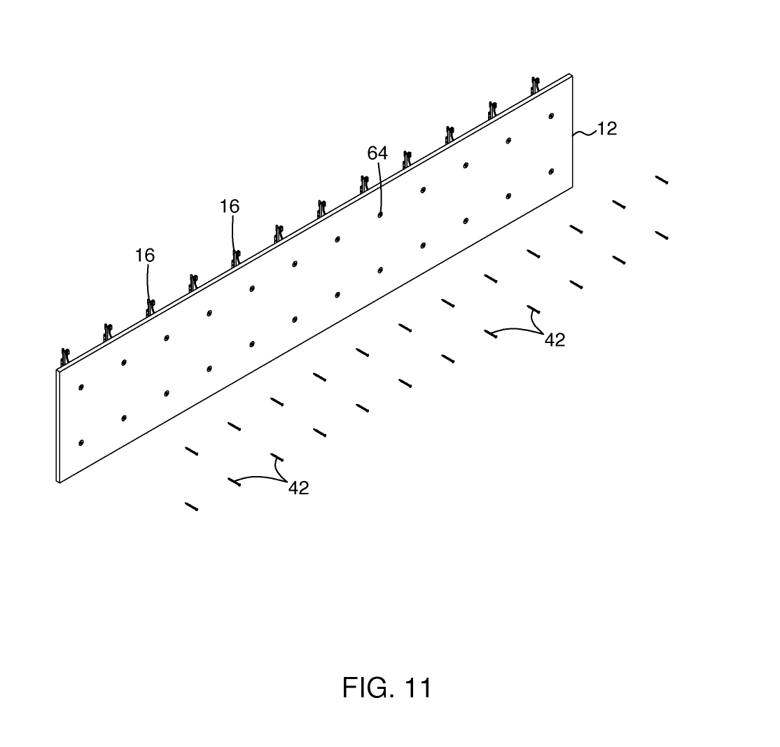

Now referring to FIGS. 10 and 11, in addition to FIGS. 1, 8 and 9, the second member 40 is used in cooperation with the cavity shaping discrete protrusions 34 of the detachable panel 12 to removably secure or removably attach the detachable panel 12 to the foam panel 14. Indeed, and as illustrated in FIGS. 8 and 10, the second member 40 is devised to face one of the rows of discrete protrusions 34 when the detachable panel 12 and the foam panel 14 are in the process of being removably attached to one another. The expression “removably attaching” refers to the ability of the detachable panel 12 to be temporarily connected to the foam panel 14 which is illustratively shown by removably securing the detachable panel 12 to the connectors 16 during the creation of the form and during the pouring of the flowable material. The expression “removably attaching” also refers to the ability of the detachable panel 12 to be relatively easily removed from the foam panel 14 which is illustratively done by removably unsecuring the detachable panel 12 from the connectors 16 when desired, such as upon the flowable material hardening, for example. Each of the cavity shaping discrete protrusions 34 is adapted for facilitating the securing of the second member 40 to the detachable panel 12 in order to support and fix the detachable panel 12 to the second member 40 during the formation of the wall formation 28, for example by using removable fasteners 42 insertable through the discrete protrusions 34 and the sleeves 50 as will be further described hereinbelow.

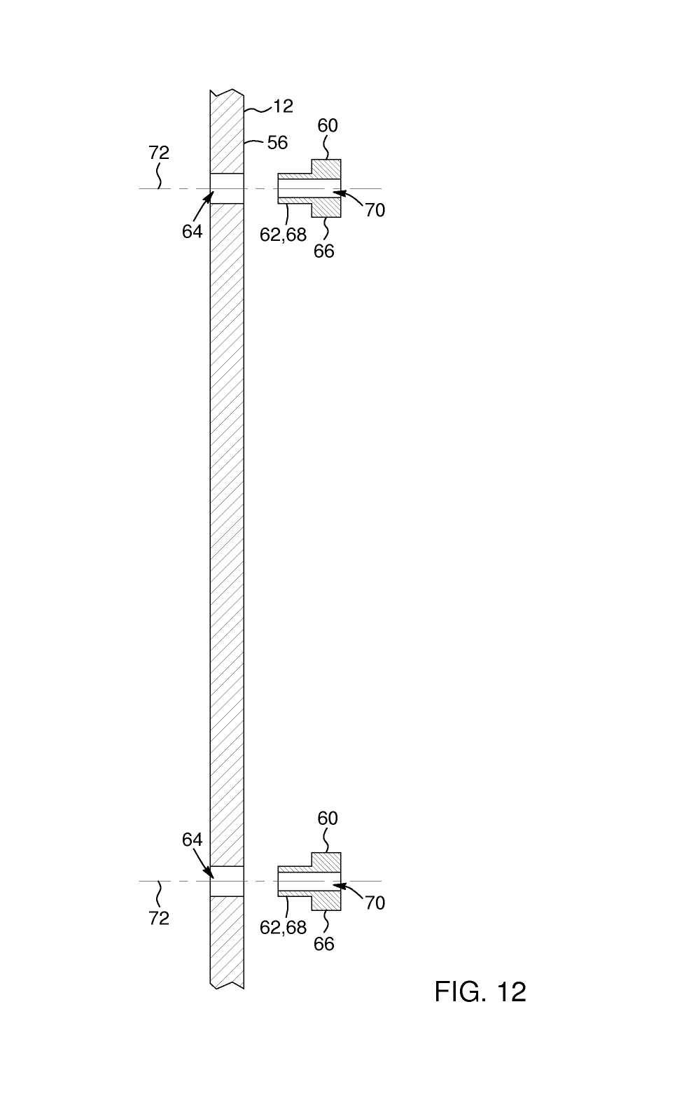

Now referring to FIG. 12, in addition to FIGS. 5 and 9, each of the cavity shaping discrete protrusions 34 may illustratively be embodied as an insertable peg 60 having an inner portion 62 of which is receivable within a countersunk or counterbored panel recess or through hole 64 provided in the detachable panel 12 and secured therein by press-fitting for example, as better shown in FIG. 9, such that the outer portion of the peg 60 protrudes from the inner face 56 to thus form the cavity shaping discrete protrusion 34. Alternatively, in another embodiment (not illustrated), the cavity shaping discrete protrusion 34 can be integrally embodied to the detachable panel 12. As for example, if the panel 12 is made of molded plastic, the protrusions 34 could be formed by molding process of the panel using a special mold. In some optional embodiments, the cavity shaping discrete protrusions 34 may be illustratively formed from a wider annular shoulder portion 66 connected to annular head portion 68 illustratively countersunk or counterbored in the detachable panel 12 and secured therein by press-fit into the through hole 64 for example, such that the annular shoulder portion 66 projects from the interior face 56 of the detachable panel 12 to thus form the cavity shaping discrete protrusion 34. Of note, while the cavity shaping discrete protrusions 34 have been illustratively described herein as cylindrical, other shapes of cavity shaping discrete protrusions 34 may be provided to create correspondingly shaped recessed cavities in the outer surface 30 of the concrete wall formation 28. In the embodiment illustrated, the securing of the pegs 60 by press-fitting within a countersunk or counterbored panel recess or through hole 62 provided in detachable panel 12 permits the protrusions 34 embodied by the outer portion of the peg 60 to be removed from the wall formation 28 along with the removal of the detachable panel 12 after the flowable material has set and hardened in the void 32 as illustrated in FIG. 5. Of note, in the following description, the terms cavity shaping discrete protrusion 34 or peg 60 are referred to interchangeably, knowing that it is only the outer portion of the peg 60, for example the annular shoulder portion 66, that equals the protrusions 34.

Still referring to FIGS. 9 and 12, in addition to FIG. 11, in the embodiment illustrated, the peg 60 is “fastener-receiving”, meaning that it can receive the fastener 42 or other suitable mechanical fastener such as a screw which would permit the fastener 42 to pass therethough and towards the sleeve 50. For example, as illustrated in FIG. 12, the peg 60 is hollowed so as to form a hollow tube structure having an open passage 70 for example, to receive a fastener 42 inserted therethrough, and thus allow the fastener 42 to extend into the fastener-receiving sleeve 50 when the pegs 60 and the sleeves 50 are aligned along an alignment path 72 which illustratively corresponds to the axial centers of the pegs 60 and the sleeves 50. The fastener 42 will matingly engage the sleeve 50 after having passed through the corresponding peg 60 to thereby removably attach the detachable panel 12 together with the second member 40. Of note, the fastener-receiving peg 60 (or cavity shaping discrete protrusion 34) may be configured to allow the fastener 42 to unabatingly pass through the open passage 70 and onwards towards and within the sleeve 50, or the open passage 70 may be provided with threads there along for engaging corresponding fastener threads provided on the fastener 42 when received within open passage 70, for example during rotation of the screw embodiment of the fastener 42 in the open passage 70.

Still referring to FIG. 9, in addition to FIGS. 5, 10 and 11, the detachable panel 12 and the foam panel 14 are removably attached by positioning second elongated side 40 of the connector 16 to face one of the rows of the discrete protrusions 34 such that the exterior face 54 of each sleeve 50 is aligned to abut the interior protrusion surface 58 of the corresponding cavity shaping discrete protrusion 34 secured to the detachable panel 12, as previously described hereinabove. As shown in FIG. 9, when the interior protrusion surfaces 58 of the cavity shaping discrete protrusions 34 are brought flush to abut the corresponding exterior faces 54 of the sleeves 50, fasteners 42 can be received into each sleeve 50 via the cavity shaping discrete protrusions 34, thereby removably securing the detachable panel 12 to the second member 40, and thus the foam panel 14. Alternatively, the detachable panel 12 can be prefabricated with the connectors 16 attached so that the one or more cavity shaping discrete protrusions 34 are pre-connected to corresponding sleeves 50. Once the panels 12,14 are tied or attached together via the connector 16, the wall form assembly 10 is ready to receive the flowable material which will set and harden into a desired formation 28.

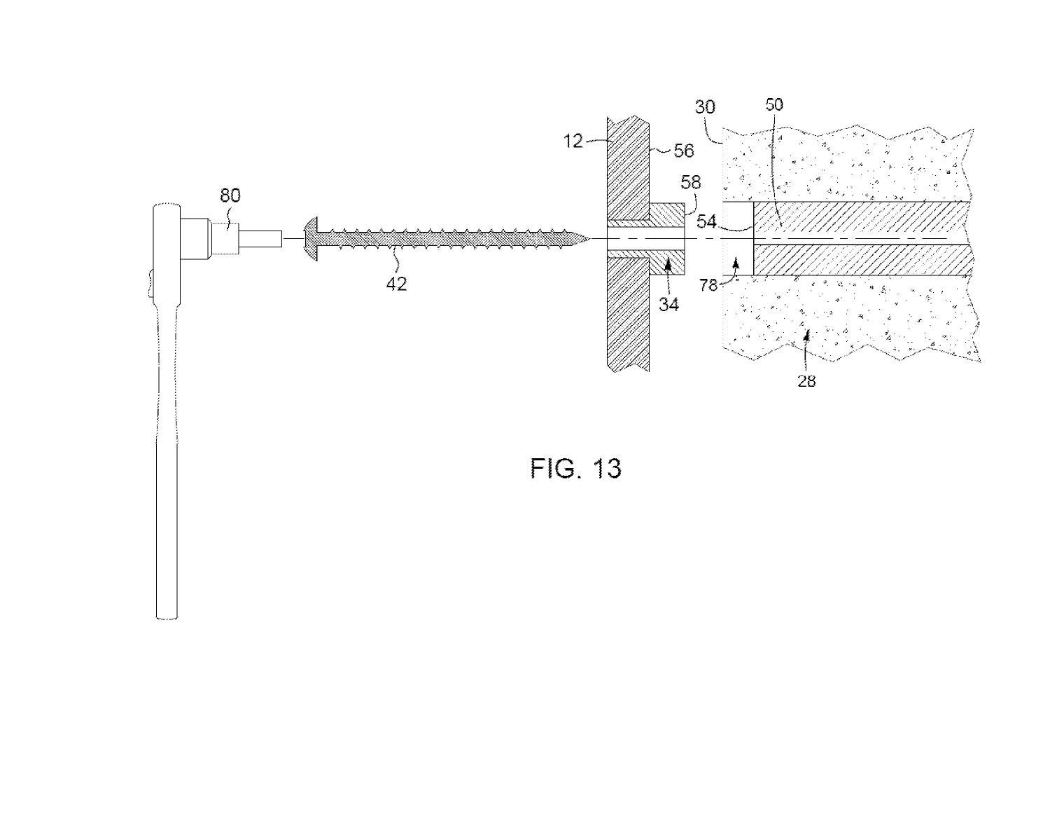

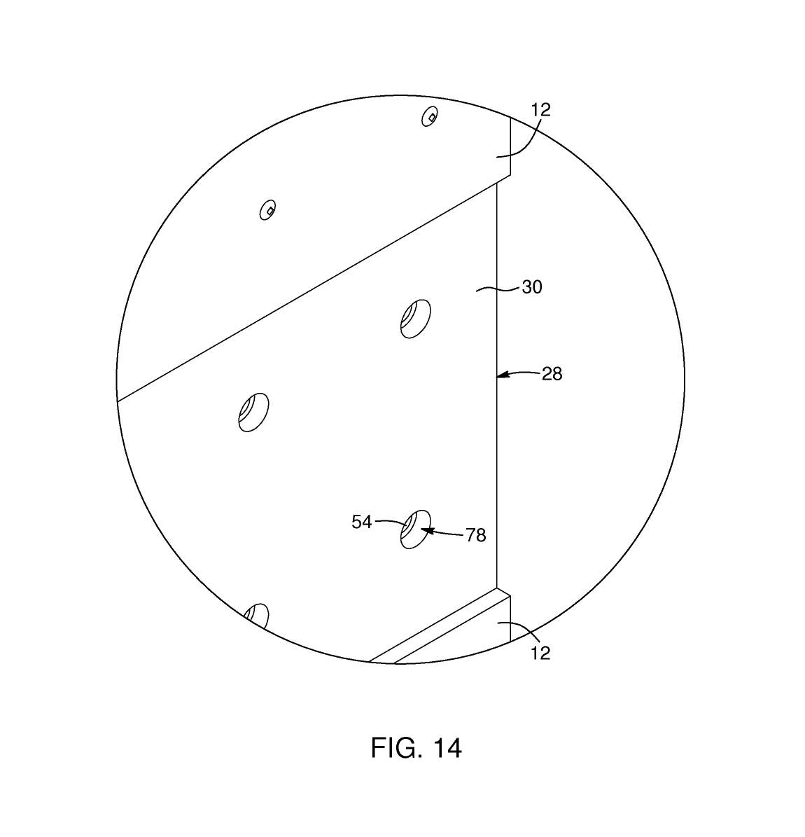

Now referring to FIGS. 13 and 14, in addition to FIGS. 5 and 9, the projecting configuration of the cavity shaping discrete protrusions 34 from the interior face 56 of the detachable panel 12 into the void 32 allows for the creation of a plurality of recessed cavities 78 within the exposed outer surface 30 of the wall formation 28. Indeed, once the flowable material has set and hardened, the detachable panel 12 is removed by removing the removable fasteners 42, thereby leaving a plurality of recessed cavities 78 within the exposed outer surface 30 of the formation 28, as best shown in FIGS. 13 and 14. The detachable panel 12 can be removed by simply unscrewing the fastener 42 by means of a tool 80, such as a ratchet or screw driver. Once the fastener 42 has been removed from the sleeve 50, the detachable panel 12, along with the one or more cavity shaping discrete protrusions 34, may be pulled away from the formation 30 to expose the recessed cavities 78 formed on the outer surface 30 of the wall formation 28. It can thus be appreciated that the removal of the detachable panel 12 leaves a smooth and protrusion-free exposed outer surface 30, which can include multiple locations having embedded sleeves 50 and exterior faces 54 which are recessed from the exposed outer surface 30. The recessed cavities 78 may act as anchor points to allow for the mounting of appropriate fixtures or supports to the exposed outer surface 30 once the detachable panel 12 has been removed. Alternatively, the recessed cavities 78 can be filled in.

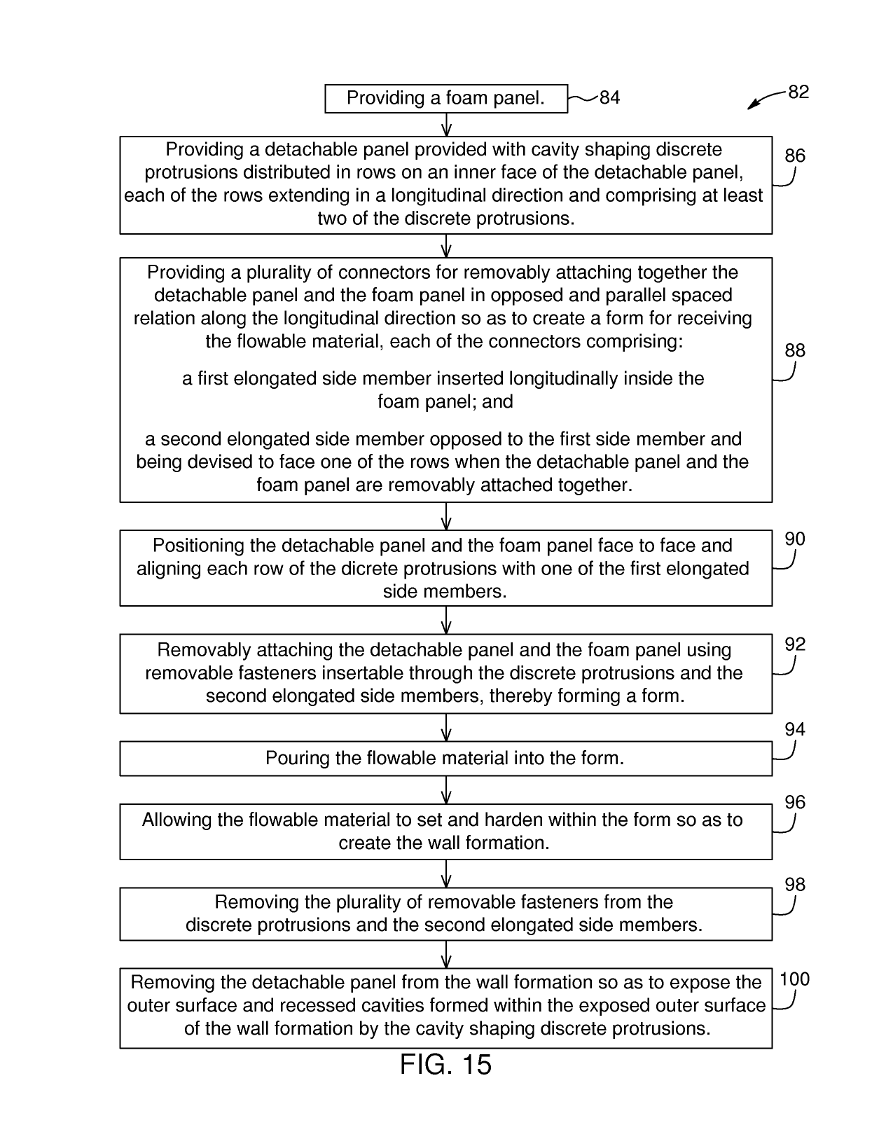

According to another aspect of the present invention, there is provided a method 82 for creating a desired formation from a flowable material. Examples of the steps of the method 82 are provided in FIGS. 1 to 15. The method 82 includes the steps of providing 84 a foam panel, providing 86 a detachable panel provided with cavity shaping discrete protrusions distributed in rows on an inner face of the detachable panel, with each of the rows extending in a longitudinal direction and comprising at least two of the discrete protrusions. The method 82 further includes the step of providing 88 a plurality of connectors for removably attaching together the detachable panel and the foam panel in opposed and parallel spaced relation along the longitudinal direction so as to create a form for receiving the flowable material, with each of the connectors having a first elongated side member inserted longitudinally inside the foam panel, and a second elongated side member opposed to the first side member and being devised to face one of the rows when the detachable panel and the foam panel are removably attached together. The method 82 further includes the step of positioning 90 the detachable panel and the foam panel face to face and aligning each row of the discrete protrusions with one of the first elongated side members then removably attaching 92 the detachable panel and the foam panel using removable fasteners insertable through the discrete protrusions and the second elongated side members, thereby forming a form. The method 82 further includes the step of pouring 94 the flowable material into the form and allowing 96 the flowable material to set and harden within the form so as to create the wall formation. The method 82 further includes the steps removing 98 the plurality of removable fasteners from the discrete protrusions and the second elongated side members, and removing 100 the detachable panel from the wall formation so as to expose the outer surface and recessed cavities formed within the exposed outer surface of the wall formation by the cavity shaping discrete protrusions.

The method 82 further comprises the step of reinforcing the at least one screw-receiving sleeve against loads generated by the flowable material.

In light of the preceding, it can thus be appreciated that the present invention allows for the creation of a wall formation 28 from which an exposed outer surface 30 thereof can be quickly and easily revealed, the exposed outer surface 30 providing a smooth and protrusion-free surface with formed recessed cavities 78 formed therein for being used or displayed as desired.

Although optional embodiments of the invention have been described in detail herein and illustrated in the accompanying drawings, it is to be understood that the invention is not limited to those precise embodiments and that various changes and modifications may be effected therein without departing from the scope of the invention.

1. A wall form assembly for receiving a flowable material that sets and hardens into a desired formation having an exposed outer surface, the assembly comprising:
a detachable panel provided with cavity shaping discrete protrusions distributed in rows on an inner face of the detachable panel, each of the rows extending in a longitudinal direction and comprising at least two of the discrete protrusions;
a foam panel;
a plurality of connectors for removably attaching together the detachable panel and the foam panel in opposed and parallel spaced relation along the longitudinal direction so as to create a form for receiving the flowable material, each of the connectors comprising:
a first elongated side member inserted longitudinally inside the foam panel; and
a second elongated side member opposed to the first side member and being devised to face one of the rows of the discrete protrusions when the detachable panel and the foam panel are attached together; and
a plurality of removable fasteners insertable through the discrete protrusions and the second elongated side members of the plurality of connectors to removably attach the detachable panel to the connector;
whereby, once the flowable material has set and hardened, the detachable panel is removed by removing the removable fasteners; thereby leaving a plurality of recessed cavities within the exposed outer surface of the formation.

2. The wall form assembly of claim 1, wherein the cavity shaping discrete protrusions are insertable pegs, each insertable peg being receivable within a through hole in the detachable panel to protrude from the inner face of the detachable panel for forming one of the cavity shaping discrete protrusions.

3. The wall form assembly of claim 2, wherein each one of the insertable pegs is press-fitted within the through hole.

4. The wall form assembly of claim 3, wherein each of the insertable pegs comprise a head portion press-fitted into the through hole, and a wider shoulder portion which protrudes from the inner face of the detachable panel.

5. The wall form assembly of claim 2, wherein the insertable pegs are hollowed to receive one of the removable fasteners there through.

6. The wall form assembly of claim 1, wherein the fasteners are screws.

7. The wall form assembly of claim 6, wherein the second side member of each of the connectors comprises:
an elongated support frame; and
at least one screw-receiving sleeve extending transversally from the support frame for receiving one of the screws.

8. The wall form assembly of claim 7, wherein the at least one screw-receiving sleeve has a free end for abutting against one of the cavity shaping discrete protrusions when the detachable panel and the foam panel are attached together.

9. The wall form assembly of claim 7, wherein the second side member further comprises a reinforcing structure to reinforce the at least one screw-receiving sleeve against loads generated by the flowable material.

10. The wall form assembly according to claim 9, wherein the reinforcing structure expands between the free end of each of the at least one screw-receiving sleeve toward the elongated support frame so as to form a substantially triangular shape.

11. The wall form assembly according to claim 10, wherein the reinforcing structure has at least one retaining member for receiving and retaining a horizontally-disposed reinforcing bar.

12. A wall form assembly according to claim 7, wherein the at least one screw-receiving sleeve are vertically aligned.

13. The wall form assembly of claim 1, wherein the cavity shaping discrete protrusions are cylindrically shaped.

14. A method for creating a wall formation from a flowable material that sets and hardens, the method comprising the steps of:
a) providing a foam panel;
b) providing a detachable panel provided with cavity shaping discrete protrusions distributed in rows on an inner face of the detachable panel, each of the rows extending in a longitudinal direction and comprising at least two of the discrete protrusions;
c) providing a plurality of connectors for removably attaching together the detachable panel and the foam panel in opposed and parallel spaced relation along the longitudinal direction so as to create a form for receiving the flowable material, each of the connectors comprising:
a first elongated side member inserted longitudinally inside the foam panel; and
a second elongated side member opposed to the first side member and being devised to face one of the rows when the detachable panel and the foam panel are removably attached together;
d) positioning the detachable panel and the foam panel face to face and aligning each row of the discrete protrusions with one of the first elongated side members;
e) removably attaching the detachable panel and the foam panel using removable fasteners insertable through the discrete protrusions and the second elongated side members, thereby forming a form;
f) pouring the flowable material into the form;
g) allowing the flowable material to set and harden within the form so as to create the wall formation;
h) removing the plurality of removable fasteners from the discrete protrusions and the second elongated side members; and
i) removing the detachable panel from the wall formation so as to expose the outer surface and recessed cavities formed within the exposed outer surface of the wall formation by the cavity shaping discrete protrusions.

15. The method for creating a wall formation of claim 14, wherein the fasteners are screws and the second elongated side member of each of the plurality of connectors further comprises:
an elongated support frame; and
at least one screw-receiving sleeve extending transversally from the support frame for receiving one of the plurality of removable fasteners.

16. A method according to claim 14, further comprising the step of reinforcing the at least one screw-receiving sleeve against loads generated by the flowable material.
